(19) United States
(12) Patent Application Publication
(10) Pub. No.: US 2026/0352407 A1
(43) Pub. Date: Nov. 5, 2026

(54) METHOD AND DEVICE FOR SIGNAL CONFIGURATION AND MEASUREMENT

(71) Applicant: Samsung Electronics Co., Ltd., Suwon-si, Gyeonggi-do (KR)

(72) Inventors: Pengru LI, Beijing (CN); Qi XIONG, Beijing (CN); Miao ZHOU, Beijing (CN); Feifei SUN, Beijing (CN)

(21) Appl. No.: 19/106,457

(22) PCT Filed: Aug. 22, 2023
(86) PCT No.: PCT/KR2023/012401

§ 371 Date: Feb. 25, 2025

(30) Foreign Application Priority Data
Aug. 25, 2022 (CN) 202211028653.1
Dec. 7, 2022 (CN) 202211567664.7

(51) Int. Cl. H04L 5/00; H04W 56/00

(52) U.S. Cl. CPC H04L 5/0051; H04W 56/0035

(57) ABSTRACT

The disclosure relates to a 5G or 6G communication system for supporting a higher data transmission rate.

### CROSS-REFERENCE TO RELATED APPLICATION(S)

This application is a U.S. National Stage application under 35 U.S.C. § 371 of an International application number PCT/KR2023/012401, filed on Aug. 22, 2023, which is based on and claims priority of a Chinese patent application number 202211028653.1, filed on Aug. 25, 2022, in the Chinese Intellectual Property Office, and of a Chinese patent application number 202211567664.7, filed on Dec. 7, 2022, in the Chinese Intellectual Property Office, the disclosure of each of which is incorporated by reference herein in its entirety.

### TECHNICAL FIELD

The present disclosure relates to a wireless communication technology, and more particularly, to a method and a device for configuration and measurement of a signal.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT) to flexibly accommodate various services/applications with different requirements, new multiple access schemes to support massive connections, and so on.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE

### Technical Problem

There is a need in the art to provide a method and device for signal configuration or measurement.

The technical subjects pursued in the disclosure may not be limited to the above mentioned technical subjects, and other technical subjects which are not mentioned may be clearly understood, through the following descriptions, by those skilled in the art to which the disclosure pertains.

### Technical Solution

According to an aspect of the present disclosure, there is provided a method performed by a second user equipment (UE) in a communication system, comprising: receiving configuration information for resources; measuring first signal based on the configuration information for resources, wherein the first signal is signal(s) or signal resource(s) or signal resource set(s) for positioning.

According to an embodiment of the present disclosure, the second UE receives the configuration information for resources from a network node or the second UE receives the configuration information for resources from a first UE.

According to an embodiment of the present disclosure, the user equipment receives the configuration information for resources through physical layer signaling or higher layer signaling.

According to an embodiment of the present disclosure, the configuration information for resources includes at least one of the following: an identify (ID) of the first signal, a repetition index ID of the first signal, a ID of the UE, a UE group ID, a mapping pattern of the first signal in time domain and/or frequency domain, a starting point of the first signal, a time duration of the first signal, a periodicity of the first signal, a bandwidth of the first signal, a priority of the first signal, and a timestamp of the first signal.

According to an embodiment of the present disclosure, the timestamp of the first signal include at least one of the following: an initial value D and a step size S, wherein D and s are parameter values reported by the UE, and/or parameter values configured by the network node, and/or preconfigured parameter values, and D and s are real numbers greater than 0.

According to an embodiment of the present disclosure, the priority of the first signal is a parameter value reported by the user equipment (UE), and/or a parameter value configured by the network node, and/or a preconfigured parameter value and/or a default parameter value.

According to an embodiment of the present disclosure, the mapping pattern received by the second UE is different from the mapping pattern received by other UEs belonging to the same UE group as that the second UE belongs to; and/or the mapping pattern received by the second UE is different from the mapping pattern received by a UE adjacent to the second UE.

According to an embodiment of the present disclosure, the configuration information for resources includes a dedicated resource pool or a shared resource pool configured by the network node or the first UE, resources are reserved for transmission of the first signal in the dedicated resource pool or the shared resource pool.

According to an embodiment of the present disclosure, frequency domain resources are reserved for transmission of the first signal with a granularity of continuous N sub-channels in the frequency domain, and time domain resources are reserved for transmission of the first signal with a granularity of continuous or discontinuous T slots in the time domain, where N and T are parameter values reported by the user equipment (UE), and/or parameter values configured by the network node, and/or pre-configured parameter values, wherein N and T are real numbers greater than or equal to 1.

According to an embodiment of the present disclosure, when resources are reserved for transmission of the first signal in the shared resource pool, time-frequency resources allocated for a shared channel PSSCH and/or a control channel PSCCH are occupied, and time-frequency resources allocated for automatic gain control AGC and/or a guard period GP are not occupied.

According to an embodiment of the present disclosure, the method further comprises: receiving configuration information for a first unit for measuring the first signal, wherein the first unit is one of the following: a measurement gap for measuring the first signal, or a processing window for the first signal, or a time domain unit for measuring the first signal, or a time duration L starting from a starting position S of resources for the first signal transmission, or the M first signals starting from a starting position S of the resources for the first signal transmission.

According to an embodiment of the present disclosure, the configuration information for the first unit includes at least one of the following: the periodicity of the first unit, the starting position S of the first unit, the time duration L of the first unit, and the bandwidth B of the first unit, wherein the starting position S is a slot and/or subframe and/or system frame when the UE starts measuring the first signal, wherein the time duration L is a time length when the UE measures the first signal from the starting position S, wherein the M first signal is M first signal that are continuous or discontinuous in time domain, wherein at least one of the bandwidth B, the starting position S, the time duration L and the number M is a parameter value reported by the user equipment UE, and/or a parameter value configured by a network node and/or a pre-configured parameter value, wherein B, S, L and M are real numbers greater than 0.

According to an embodiment of the present disclosure, the first unit is configured and/or activated based on a request of a network device or the second UE, and measuring the first signal based on the configuration information for resources includes measuring the first signal within the first unit.

According to an embodiment of the present disclosure, the second UE transmits a request for configuring and/or activating the first unit to the first UE, wherein the first unit is configured and/or activated by the first UE, or the first unit is configured and/or activated to be used for the second UE by the first UE transmitting the request for configuring and/or activating the first unit to a network node; or the second UE transmits the request for configuring and/or activating the first unit to other UEs belonging to the same UE group as that the second UE belonging to, wherein the request is forwarded by the other UEs to the first UE, and the first unit is configured and/or activated through the first UE, or the first unit is configured and/or activated to be used for the second UE by the first UE transmitting the request for configuring and/or activating the first unit to a network node; or the second UE transmits the request for configuring and/or activating the first unit to the first UE, and the second UE transmits information for the activated first unit to other UEs belonging to the same UE group as that the second UE belonging to, wherein the first unit is configured and/or activated by the first UE, or the first unit is configured and/or activated to be used for the second UE by the first UE transmitting the request for configuring and/or activating the first unit to a network node.

According to an embodiment of the present disclosure, each first unit has corresponding identity (ID), and the first unit is activated or deactivated through the ID.

According to an embodiment of the present disclosure, when sensing result of the resources for the first signal transmission in the first unit satisfies first condition, the first unit for the first signal measurement is configured and/or activated.

According to an embodiment of the present disclosure, the first condition is the number of the resources for the transmission of the first signal sensed by the first UE being greater than a first threshold value; and/or the time duration of the resource for transmission of the first signal sensed by the first UE being greater than a second threshold value.

According to an embodiment of the present disclosure, the first condition includes at least one of the following:
in case that the first UE receives a request in which the second UE request to configure and/or activate the first unit, the number of the resources for the first signal transmission sensed by the first UE is greater than a third threshold or the time duration of the resources for the first signal transmission sensed by the first UE is greater than a fourth threshold, wherein the first unit is configured and/or activated by a network node or the first UE;
in case that the second UE does not reserve resources for the first signal transmission during sensing procedure, and the second UE informs the first UE of the number or the time duration of the resources for the first signal transmission, the number of the resources for the first signal transmission is greater than a fifth threshold or the time duration of the resources of the first signal transmission is greater than a sixth threshold, wherein the first unit is configured and/or activated by the network or the first UE;
in case that the second UE does not reserve resources for the first signal transmission during sensing procedure, the number of the resources for the first signal transmission sensed by the second UE is greater than a seventh threshold value or the time duration of the resources for the first signal transmission sensed by the second UE is greater than an eighth threshold value, wherein the first unit is configured and/or activated by a network device requested by the second UE or the first UE; or
in case that the first UE senses one or more resources for the first signal transmission, or the first UE requests the network to configure the first signal, the number of the resources selectable by other UEs for transmission of the first signal, among the resources suggested by the first UE, is greater than a ninth threshold or the time duration of the resources selectable by the other UEs for transmission of the first signal, among the resources suggested by the first UE, is greater than a tenth threshold, wherein the first unit is configured and/or activated by a network device, the first UE or other UEs, and the other UEs belong to the same UE group as that the second UE belonging to.

According to an embodiment of the present disclosure, the granularity of the number of the resources for the first signal transmission may be the number of signal resources or resource sets or the number of slots in which the signal resources or the resource sets can be transmitted.

According to an embodiment of the present disclosure, at least one of the first threshold, the second threshold, the third threshold, the fourth threshold, the fifth threshold, the sixth threshold, the seventh threshold, the eighth threshold, the ninth threshold and the tenth threshold is a parameter value reported by the user equipment UE, and/or a parameter value configured by a network node, and/or a preconfigured parameter value.

According to an embodiment of the present disclosure, the first signal in the first unit is the first signal which has a high priority and/or does not collide or overlap with other signals or channels and unmuted.

According to an embodiment of the present disclosure, the starting position of the first unit for the first signal measurement is equal to the starting position of the latest next signal configured and/or activated by the network device for the second UE.

According to an embodiment of the present disclosure, the second UE measures the first signal in the configured and/or activated first unit, and the first UE reserves the resources for the first signal transmission in the configured and/or activated first unit.

According to an embodiment of the present disclosure, the resources for the first signal transmission are reserved based on sensing or random selection by the first UE in the resource pool, and the first signal is transmitted on the reserved resources by the first UE or the first signal is activated by the first UE.

According to an embodiment of the present disclosure, the second UE does not reserve resources in the resource pool during sensing procedure, and the second UE informs the first UE to select at least a part of the resources for the first signal transmission among the suggested resources.

According to an embodiment of the present disclosure, the resources for the transmission of the first signal for other UEs belonging to the same UE group as that the second UE belonging to are reserved by the first UE, or the sensing result or suggested resources in the resource pool by the first UE is transmitted to the other UEs by the first UE.

According to an embodiment of the present disclosure, the suggested resources can be represented by a bitmap.

According to an embodiment of the present disclosure, the first unit is an activated first unit, or a first unit activated by the network and/or the first UE requested by the second UE.

According to an embodiment of the present disclosure, the available time-frequency resources may be unoccupied time-frequency resources and/or time-frequency resources occupied by a signal or a channel with a lower priority than that of the current first signal.

According to another aspect of the present disclosure, there is provided a method performed by a first user equipment (UE) in a communication system, comprising: obtaining configuration information for resources; transmitting the configuration information for resources to a second UE, wherein the configuration information is for measuring first signal, and the first signal is signal(s) or signal resource(s) or signal resource set(s) for positioning.

According to an embodiment of the present disclosure, the configuration information for resources includes at least one of the following: an identity (ID) of the first signal, a repetition index ID of the first signal, an ID of the UE, a UE group ID, a mapping pattern of the first signal in time domain and/or frequency domain, a starting point of the first signal, time duration of the first signal, a periodicity of the first signal, a bandwidth of the first signal, a priority of the first signal, and a timestamp of the first signal.

According to another aspect of the present disclosure, there is provided a user equipment (UE) in a wireless communication system, which includes a transceiver configured to receive and transmit a signal; and a controller coupled with the transceiver and configured to control the UE to perform the method according to the embodiment of the present disclosure.

Through the method and device for signal configuration and measurement provided by the present disclosure, quick and effective signal configuration and measurement can be achieved.

### Advantageous Effects

The present disclosure provides an effective and efficient method for signal configuration or measurement. Advantageous effects obtainable from the disclosure may not be limited to the above mentioned effects, and other effects which are not mentioned may be clearly understood, through the following descriptions, by those skilled in the art to which the disclosure pertains.

### DESCRIPTION OF DRAWINGS

FIG. 1 illustrates an example wireless network according to various embodiments of the present disclosure;

FIGS. 2A and 2B illustrate example wireless transmission and reception paths according to the present disclosure;

FIG. 3A shows an example user equipment UE according to the present disclosure;

FIG. 3B shows an example base station according to the present disclosure;

FIG. 4 is a flowchart of a method according to an embodiment of the present disclosure.

### MODE FOR INVENTION

The following description with reference to the accompanying drawings is provided to facilitate a comprehensive understanding of various embodiments of the present disclosure defined by the claims and their equivalents. This description includes various specific details to facilitate understanding but should only be considered as exemplary. Therefore, those skilled in the art will recognize that various changes and modifications can be made to the various embodiments described herein without departing from the scope and spirit of the present disclosure. In addition, for the sake of clarity and conciseness, description of well-known functions and structures may be omitted.

The terms and expressions used in the following specification and claims are not limited to their dictionary meanings, but are only used by the inventors to enable a clear and consistent understanding of the present disclosure. Therefore, it should be obvious to those skilled in the art that the following description of various embodiments of the present disclosure are provided for illustration purposes only and are not intended to limit the purposes of the present disclosure as defined in the appended claims and their equivalents.

It should be understood that singular forms of “a”, “an” and “the” include plural referents unless the context clearly indicates otherwise. Thus, for example, a reference to a “component surface” includes a reference to one or more such surfaces.

The terms “include” or “may include” refer to the existence of a function, operation or component disclosed accordingly that can be used in various embodiments of the present disclosure, and do not limit the existence of one or more additional functions, operations or features. In addition, the terms “including” or “having” can be interpreted as indicating certain characteristics, numbers, steps, operations, constituent elements, components or combinations thereof, but should not be interpreted as excluding the possibility of the existence of one or more other characteristics, numbers, steps, operations, constituent elements, components or combinations thereof.

The term “or” used in various embodiments of the present disclosure includes any of the listed terms and all combinations thereof. For example, “A or B” may include A, may include B, or may include both A and B.

Unless defined differently, all terms (including technical terms or scientific terms) used in the present disclosure have the same meaning as those understood by those skilled in the art to which the present disclosure belongs. Common terms, as defined in dictionaries, are interpreted as having meanings consistent with the context in the relevant technical fields, and should not be interpreted in an idealized or overly formal way unless explicitly defined in the present disclosure.

The technical solution of the embodiment of the present disclosure can be applied to various communication systems, such as the Global System for Mobile Communications (GSM) system, code division multiple access (CDMA) system, wideband code division multiple access (WCDMA) system, general packet radio service (GPRS), long term evolution (long term evolution, LTE) system, LTE frequency division duplex (FDD) system, LTE time division duplex (TDD), universal mobile telecommunications system (UMTS), worldwide interoperability for microwave access (WiMAX) communication system, 5th generation (5G) system or new radio (NR), etc. In addition, the technical solution of the embodiment of the present disclosure can be applied to future-oriented communication technologies, such as 6G.

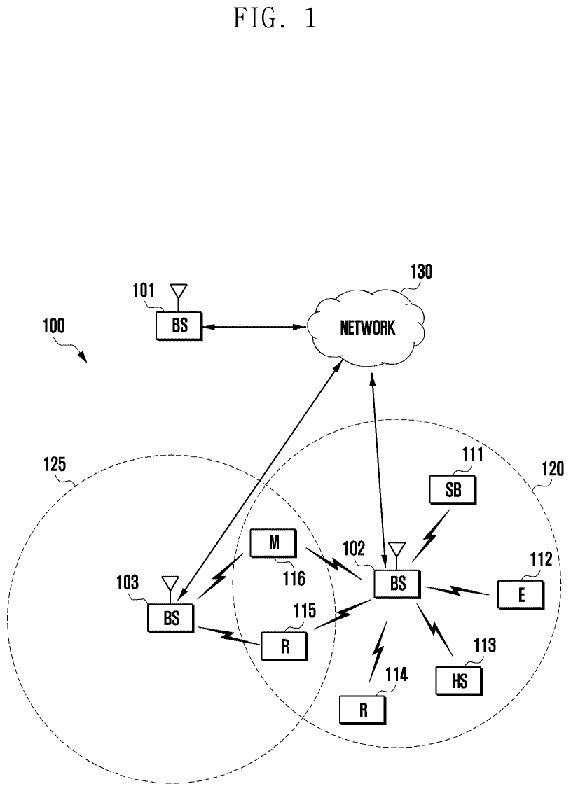

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of user equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

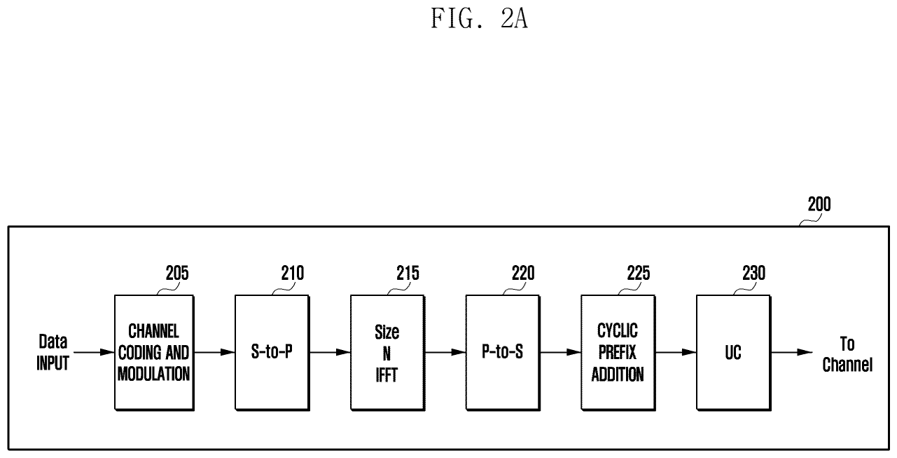

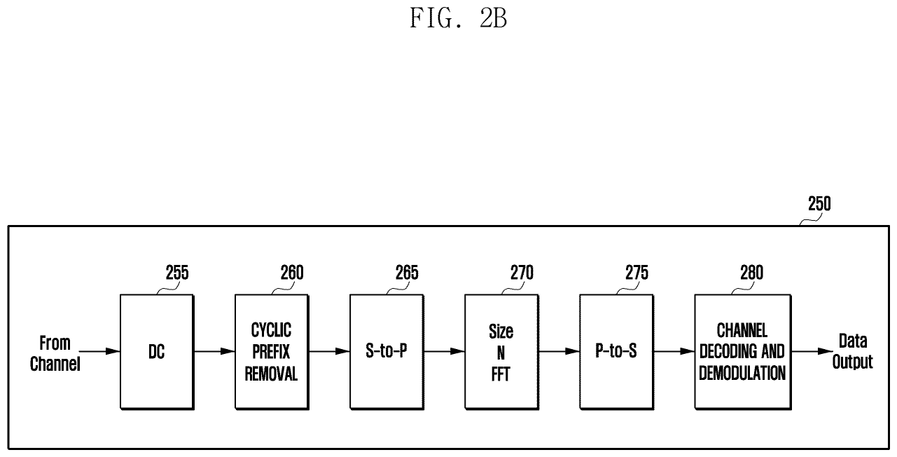

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

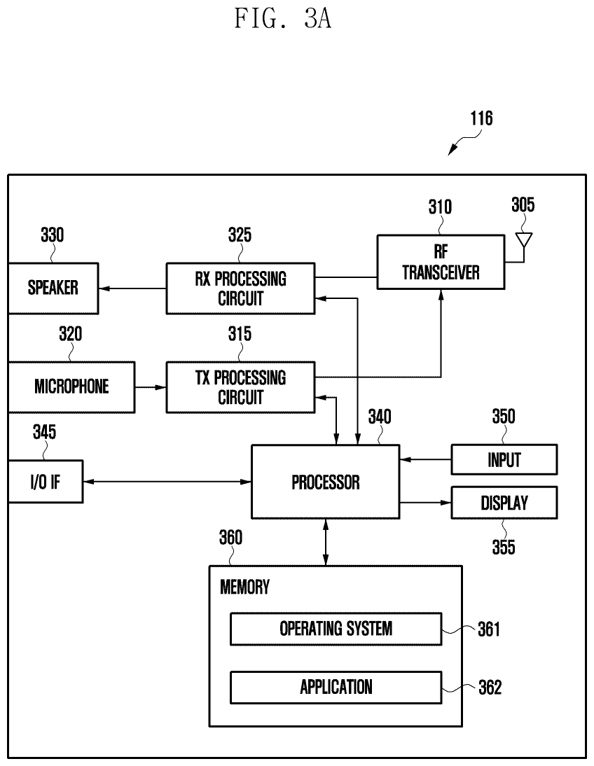

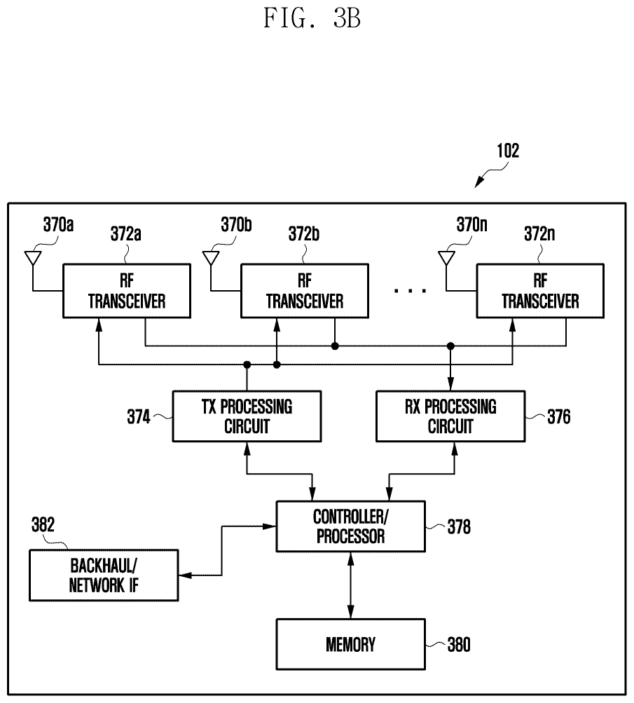

FIG. 3A illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of indication, such as the BIS algorithm, are stored in the memory. The plurality of indication are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (also called time unit) in this disclosure can be an OFDM symbol, an OFDM symbol group (composed of multiple OFDM symbols), a slot, a slot group (composed of multiple slots), a subframe, a subframe group (composed of multiple subframes), a system frame and a system frame group (composed of multiple system frames); it can also be an absolute time unit, such as 1 millisecond, 1 second, etc. A time unit can also be a combination of various granularities, such as N1 slots plus N2 OFDM symbols, where N1 and N2 are positive integers.

A frequency domain unit (also called frequency unit) in this disclosure can be a subcarrier, a subcarrier group (composed of multiple subcarriers), a resource block (RB), also called physical resource block (PRB), a resource block group (composed of multiple RBs), a bandwidth part (BWP), a bandwidth part group (composed of multiple BWPs), a band/carrier, a band group/carrier group; it can also be an absolute frequency domain unit, such as 1 Hz, 1 kHz, etc. The frequency domain unit can also be a combination of multiple granularities, such as M1 PRBs plus M2 subcarriers, where M1 and M2 are positive integers.

In this disclosure, as understood by those skilled in the art, that resources are “configured” by the network may mean that the UE can directly use the resources after the network performs configuration; that resources are “pre-configured” by the network may mean that after the network performs pre-configuration, the UE may still need to request activation of the resources before the UE can use the resources, However, the meanings of “configuration” and “pre-configuration” in the present disclosure are not limited to the above meanings.

In this disclosure, unless explicitly defined, the term “greater than” can be replaced by “greater than or equal to” and the term “less than” can be replaced by “less than or equal to”, and vice versa.

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

The transmission links of a wireless communication system mainly includes: downlink communication link from a 5G New Radio (NR) gNB to a user equipment (UE), uplink communication link from a UE to a network, and sidelink (SL) communication link from a UE to a UE, which can also be called a sidelink.

Nodes for positioning measurement in a wireless communication systems, such as the current wireless communication systems, include: a UE that initiates a positioning request message and is used for downlink positioning measurement, a location management function (LMF) that is used for UE positioning and issuing positioning assistance data, a gNB or a transmission-reception point (TRP) that broadcasts positioning assistance data and performs uplink positioning measurement, and a UE that is used for sidelink positioning measurement.

The sidelink resource allocation method can be divided into two modes: one is that the base station allocates sidelink transmission resources to a terminal, that is, Mode 1; the other is that a terminal autonomously selects transmission resources, that is, Mode 2. When using Mode 1 for resource allocation, the base station can dynamically allocate transmission resources for the terminal through downlink control information DCI, or the base station can allocate semi-persistent transmission resources for the terminal, and allocate transmission resources for a positioning signal by means of configured grant (CG) resource allocation. When using Mode 2 for resource allocation, the terminal selects time-frequency resources from the resource pool configured or preconfigured by the network through sensing or random selection, for signal and/or channel transmission. When the user uses sidelink for wireless communication, a problem that needs to be solved is how to perform positioning. As an example, a problem is how to obtain transmission resources for a reference signal for sidelink positioning. As another example, a problem is how to perform measurement of the reference signal based on the sidelink positioning. Among them, the signal for positioning can be, for example, a SL PRS (Positioning Reference Signal), but the name of the signal for positioning is not limited in the present disclosure. In the following contents of the present disclosure, the SL PRS is taken as an example for the purpose of explanation, but is not used for limiting the signal for positioning.

Specifically, the disclosure proposes a method and a device for signal configuration and measurement. In an embodiment of the disclosure, the method and the device are disclosed to determine the time-frequency resources for SL PRS(s) and/or SL PRS resource(s) and/or SL PRS resource set(s), and perform measurement of SL PRS(s). In the embodiment, the SL PRS(s) is used for exemplary introduction, but the introduced method can also be used for measurement of other signals, such as a synchronization signal and PBCH block (SSB), a channel state information reference signal (CSI-RS) and so on.

In the present disclosure, unless otherwise defined or contradicted by the context, a first UE may refer to an SL initiator UE, a second UE may refer to an SL responder UE and/or an SL responder UE group, first resource may refer to the SL PRS resource(s) and/or the SL PRS resource set(s), and first resource may be used for representing the signal for positioning, such as the SL PRS, and the network may refer to the base station and/or the LMF and/or other function entity and/or other network device in the network.

The method for the second UE obtaining configuration parameters of the first resource configured or preconfigured by the network and/or the first UE may include one or combination of more of the following:
the second UE obtains the configuration parameters of one or more configured or preconfigured first resource by receiving SCI transmitted by the first UE. This way enables the SL UE to quickly obtain the configuration parameters of the first resource, thus facilitating change of the configuration of the first resource in real time;
the second UE obtains the configuration parameters of one or more configured or preconfigured first resource by receiving DCI. This way enables the UE within the coverage of the base station to quickly obtain the configuration parameters of the first resource, thus facilitating change of the configuration of the first resource in real-time;
the second UE obtains the configuration parameters of one or more configured or preconfigured first resource by receiving MAC CE. This way is more suitable for the UE to obtain some changes of the configuration parameters of the first resource that may occur within a period of time. Compared with a RRC message, the MAC CE can indicate the configuration parameters of the first resource flexibly and quickly, and thus reducing the system processing latency when indicating the configuration parameters of the first resource in a single time;
the second UE obtains the configuration parameters of one or more configured or preconfigured first resource by receiving RRC. This way is more suitable for the UE to obtain the configuration parameters of the first resource that will not change frequently within a period of time, thus reducing the uncertainty and processing latency caused by dynamic indications at multiple times;
the second UE obtains the configuration parameters of one or more configured or preconfigured first resource by receiving higher layer signaling, for example, the higher layer signaling can be a LPP (LTE Positioning Protocol) and/or a NRPPa (NR Positioning Protocol A). This way is more suitable for the situation where LMF requests the UE or the base station to configure the first resource;
the configuration parameters of the first resource include at least one of the following: an identity (ID) of the first resource, a repetition index ID of the first resource, an ID of the UE (for example, the UE here can be one or more of the following: the first UE, the second UE, a second UE A or a second UE B), and the UE group ID (for example, the UE group here can be a group including one or more of the following: the first UE, the second UE, the second UE A or the second UE B), a mapping pattern of the first resource (for example, the mapping pattern can be the mapping pattern of the first resource in time domain and/or frequency domain, which can be expressed as a comb size (comb size)), a starting point of the first resource, a time duration of the first resource, a periodicity of the first resource, a bandwidth of the first resource, a priority of the first resource, and a timestamp(timer) of the first resource;
the initial value of the timestamp(timer) of the first resource is D ms, and the timestamp (timer) of the first resource is the valid time of the configured first resource, and the initial value D of the timestamp (timer) is gradually reduced by a step size of s ms until it is 0, where D and s are the parameter values reported by the user equipment UE according to its own processing capability, and/or the parameter values configured by the base station, which are received by the UE, and/or the pre-configured parameter values, and D and s are real numbers greater than 0. Optionally, s can be equal to the time duration of one slot or preconfigured as 1 ms. If the timestamp is 0, and the currently configured first resource are not allocated with corresponding transmission resources, the currently configured first resource are dropped to prevent the UE from measuring the invalid first resource;
the priority of the first resource may be a parameter value reported by the user equipment UE according to its own processing capability, and/or a parameter value configured by the base station, which is received by the UE, and/or a preconfigured parameter value, and/or a default parameter value.

The network may configure different mapping patterns (comb size) of first resource for adjacent second UEs and/or different UEs in the same second UE group. The adjacent second UEs and/or different UEs in the same second UE group are not expected to be configured with the first resource with the same mapping pattern (comb size), so as to avoid collision or overlap between the first resources of the adjacent second UEs and/or different UEs in the same second UE group.

The UE may use a specific or dedicated or indicated resource pool configured by the network or the first UE, or a resource pool shared with other sidelink signals/channels for transmission and measurement of the SL PRS, and the method for the UE reserving one or more first resource in a indicated resource pool and/or in a shared resource pool may include one or combination of more of the following:
in order to ensure the accuracy of SL PRS measurement, in the frequency domain, the UE reserves frequency domain resources for transmission of the first resource with a granularity of consecutive N sub-channels or subcarriers in the frequency domain, that is, with a granularity of a sub-channel group or a subcarrier group. The mapping pattern of the first resource uses a comb interval (comb) in the frequency domain for mapping. In the time domain, the UE reserves time domain resources for transmission of the first resource with a granularity of T slots or symbols that are continuous or discontinuous in the time domain, i.e., with a granularity of a slot group or a symbol group;
when UE reserves transmission resources for the first resource in the shared resource pool, the first resource can only occupy the time-frequency resources allocated for PSSCH(s), and cannot occupy the time-frequency resources for Automatic Gain Control (AGC) and/or a Guard Period (GP) and PSCCH(s) to avoid collision with SCI.
when the UE reserves transmission resources for the first resource in the shared resource pool, the first resource can occupy the time-frequency resources allocated for PSSCH(s) and/or PSCCH(s), and cannot occupy the time-frequency resources where AGC and/or a GP are located, so as to avoid influence on other signals/channels;
N and T are the parameter values reported by the user equipment UE according to its own processing capability, and/or the parameter values configured by the base station which are received by the UE, and/or the pre-configured parameter values, where N and T are real numbers greater than or equal to 1. The value of N should be less than or equal to the bandwidth of the resource pool configured by the network or the first UE;
the other sidelink signals/channels include at least one of the following: physical sidelink control channel (PSCCH), physical sidelink share channel (PSSCH), physical sidelink feedback channel (PSFCH), physical sidelink broadcast channel (PSBCH), sidelink synchronization signal (S-SS), sidelink channel state information reference signal (SL CSI-RS) and sidelink phase tracking reference signal (SL PT-RS).

The network and/or the first UE may configure and/or preconfigure one or more first units for the second UE and/or the second UE group to perform measurement of the SL PRS. The configuration information for the first unit may include at least one of the following: a periodicity of the first unit, a starting position of the first unit, a time duration (length) of the first unit, and a bandwidth B of the first unit. Optionally, the bandwidth B of the first unit is less than or equal to the bandwidth of the configured resource pool. The first unit may be a measurement gap for the first resource measurement, or a processing window for the first resource, or a time domain unit for the first resource measurement, or a time duration L starting from the starting point S of transmission resources for the first resource, or M (pre-)configured or measured first resource starting from the starting point S of the transmission resources for the first resource. The starting point S is the slot and/or subframe and/or system frame in which the UE starts to measure the first resource. The time duration (length) L specifies the time length when the UE measures the first resource starting from the starting point S. The M (pre-)configured or measured first resource starting from the starting point S of the transmission resources may be M first resources that are continuous or discontinuous in the time domain, excluding muted SL PRS resource(s) or resource set(s). The bandwidth B, the starting point S, the time duration (length) L and the M first resources are the parameter values reported by the user equipment UE according to its own processing capability, and/or the parameter values configured by the base station which are received by the UE, and/or the pre-configured parameter values, where B, S, L and M are real numbers greater than 0.

After the network and/or the first UE configures and/or preconfigures the first resource for the second UE, the second UE performs measurement of a sidelink positioning reference signal in the configured and/or activated first unit. The method for configuring and/or activating the first unit may include one or combination of more of the following:
the LMF requests the base station to configure and/or activate the first unit for the first resource measurement through an NRPPa message, and the second UE only measures the first resource in the activated first unit; location measurement initiated by the LMF is helpful for the network to determine the location information of a UE in real time and provide network services for a user according to the user's location;
the second UE and/or the second UE group requests the base station to configure and/or activate the first unit for the first resource measurement through higher layer parameters or uplink control information (UCI) or UL MAC CE, and/or requests the first UE to configure and/or activate the first unit for the first resource measurement through SCI, and the second UE and/or the second UE group only measures the first resource in the activated first unit;
optionally, the second UE may request the first UE to configure and/or activate the first unit for measurement of SL PRS resources through the SCI, and the first UE may configure and/or activate the first unit for measurement of SL PRS resources for the second UE, or request the base station to configure and/or activate the first unit for measurement of SL PRS resources for the second UE. The second UE determines positioning measurement result and/or location information of the second UE by measuring the SL PRS resources in the configured and/or activated first unit. For example, the second UE outside the coverage of the base station can request the first unit for measurement of SL PRS resources from the first UE within the coverage of the base station through SCI, and the first UE within the coverage of the base station can configure and/or activate, and/or request the base station to configure and/or activate the first unit for measurement of SL PRS resources for the second UE outside the coverage of the base station;
optionally, in case that the first UE is an SL initiator UE within the coverage of the base station, the second UE A is an SL initiator UE outside the coverage of the base station, and the second UE B is an SL responder UE and/or an SL responder UE group outside the coverage of the base station, the second UE B may request the first unit for configuring and/or activating SL PRS measurement resources from the second UE A through SCI. After receiving the request for the first unit, the second UE A forwards the request to the first UE, and the first UE can configure and/or activate, and/or request the base station to configure and/or activate the first unit for measurement of SL PRS resources for the second UE B. The second UE B can also directly request the first unit for measurement of SL PRS resources from the first UE through SCI, and the first UE can configure and/or activate, and/or request the base station to configure and/or activate the first unit for measurement of SL PRS resources for the second UE B. After receiving the configuration information for the first unit, the second UE B can transmit the configuration information for the first unit to the second UE A through SCI. For example, the second UE B outside the coverage of the base station can transmit a request for the first unit to a second UE A outside the coverage of the base station through SCI, the second UE A forwards the request to the first UE within the coverage of the base station, and the first UE can configure and/or activate, and/or request the base station to configure and/or activate the first unit for measurement of SL PRS resources for the second UE B; the second UE B outside the coverage of the base station can also directly request the first unit for measurement of SL PRS resources from the first UE, and the first UE can configure and/or activate, and/or request the base station to configure and/or activate the first unit for measurement of SL PRS resources for the second UE B. After receiving the configuration information for the first unit, the second UE B can transmit the configuration information for the first unit to the second UE A through SCL
the base station or the UE (pre-)configures the first unit for measurement of SL PRS resources through higher layer signaling or RRC signaling, each first unit corresponds to an ID. The UE or the LMF can activate one or more first units via the associated ID through DCI or SCI or MAC CE or RRC or higher layer signaling to perform SL PRS measurement. The UE or the LMF can also deactivate one or more first units via the associated ID to release transmission resources. The default state of the first unit is an activated state or a deactivated state;
optionally, the second UE may request the first UE to configure and/or activate the first unit for measurement of SL PRS resources through SCI, and the first UE or the network may configure and/or activate one or more (pre-)configured the first units for the second UE, and/or activate one or more (pre-)configured the first units via the associated ID through DCI or SCI or MAC CE or RRC or higher layer signaling, for measurement of SL PRS resources of the second UE;
if the first UE reserves one or more available time-frequency resources for transmission of the first resource by sensing or randomly selecting in a resource pool (for example, a dedicated resource pool and/or a shared resource pool), the network or the first UE configures and/or activates the first unit in case that the first condition is satisfied;
optionally, the first condition is that if the number or the time duration of transmission resources for the first resource sensed by the first UE in the resource pool (for example, a dedicated resource pool and/or a shared resource pool) is greater than the respective preset threshold, the network or the first UE configures and/or activates the first unit for measuring the first resource by the second UE;
optionally, the first condition is that the second UE requests the first UE to configure and/or activate the first unit, after the first UE receives the request to configure and/or activate the first unit, when the number or the time duration of transmission resources for the first resource in the resource pool (for example, a dedicated resource pool and/or a shared resource pool) sensed by the first UE is greater than the respective preset threshold, the network or the first UE configures and/or activates the first unit, for measuring the first resource by the second UE;
optionally, the first condition is that the second UE does not reserve the resources for the first resource transmission during sensing procedure in the resource pool (for example, a dedicated resource pool and/or a shared resource pool), and the second UE informs the first UE of the number or the time duration of the transmission resources for the first resource available for transmission, when the number or time duration of the transmission resources for the first resource is greater than the respective preset threshold, the network or the first UE configures and/or activates the first unit, for measuring the first resource by the second UE;
optionally, the first condition is that the second UE does not reserve resources for the first resource transmission during sensing procedure in the resource pool (for example, a dedicated resource pool and/or a shared resource pool), when the number or time duration of transmission resources for the first resource sensed by the second UE is greater than the respective preset threshold, the second UE requests to activate the first unit, and the network or the first UE configures and/or activates the first unit, for measuring the first resource by the second UE;
optionally, in case that the first UE is an SL initiator UE within the coverage of the base station, the second UE A is an SL initiator UE outside the coverage of the base station, and the second UE B is an SL responder UE and/or an SL responder UE group outside the coverage of the base station, if the first UE determines one or more transmission resources in the resource pool based on sensing (for example, a dedicated resource pool and/or a shared resource pool), or the first UE requests the network to configure the first resource, then the first condition is that when the number or the time duration of transmission resources for the first resource that the second UE A can select among the transmission resources suggested by the first UE is greater than the respective preset threshold, the network or the first UE or the second UE A configures and/or activates the first unit, for measuring the first resource by the second UE B;
optionally, a granularity of the number of transmission resources for the first resource may be the number of SL PRS resources or resource sets or the number of slots that can transmit SL PRS resources or resource sets;
wherein the preset threshold value is a parameter value reported by the user equipment UE according to its own processing capability, and/or a parameter value configured by the base station which is received by the UE, and/or a pre-configured parameter value;
optionally, the first resource in the first unit are the first resource with high priority and/or not colliding or overlapping with other signals or channels and unmuted;
the starting position of the first unit for measurement of SL PRS resources is equal to the starting position of the nearest next SL PRS configured and/or activated by the network for the UE.

The first UE may reserve one or more available time-frequency resources for transmission of the first resource by sensing or randomly selecting in the resource pool (for example, a dedicated resource pool and/or a shared resource pool). If the second UE and/or the second UE group performs first resource measurement in the configured and/or activated first unit, the method for the first UE reserving one or more transmission resources for the first resource in the configured and/or activated first unit may include one or combination of more of the following:
after the network or the first UE configures or activates one or more first units, the first UE reserves one or more transmission resources for first resource through SCI by sensing or selecting randomly in the resource pool (for example, a dedicated resource pool and/or a shared resource pool), the first UE transmits the configured or preconfigured SL PRS on the reserved transmission resources or activates the configured or preconfigured first resource, and the second UE determine the measurement result and/or location information by measuring the first resource transmitted in the first unit, so as to reduce the resource overhead of a positioning reference signal;
after the network or the first UE configures or activates one or more first units, the second UE does not reserve available time-frequency resources during sensing procedure, and informs the first UE to select all or part of transmission resources in the suggested transmission resources for the first resource through SCI or higher layer signaling or assistance information, for the configured or preconfigured SL PRS transmission or the configured or preconfigured first resource activation, and determines the measurement result and/or location information by measuring the first resource transmitted in the first unit, so as to improve transmission efficiency of the first UE while reducing the resource overhead of a positioning reference signal;
in case that the first UE is an SL initiator UE within the coverage of the base station, the second UE A is an SL initiator UE outside the coverage of the base station, and the second UE B is an SL responder UE and/or an SL responder UE group outside the coverage of the base station, after the network or the first UE or the second UE A configures or activates one or more first units, by way of SCI or higher layer signaling or assistance information, the first UE reserves transmission resources for the first resource for the second UE A in a resource pool (for example, a dedicated resource pool and/or a shared resource pool), or transmits the result of sensing in the resource pool (for example, a dedicate resource pool and/or a shared resource pool) or a suggested transmission resources for the first resource to the second UE A, for the configured or preconfigured SL PRS transmission or the configured or preconfigured first resource activation. The second UE B determines the measurement result and/or location information by measuring the first resource transmitted in the first unit;
the suggested transmission resources for the first resource can be notified to the first UE or the network or the second UE A by using a bitmap, that is, the slot or symbol available for transmission is indicated as 1, and the slot or symbol not available for transmission is indicated as 0, and vice versa.
the first unit may be the activated first unit, that is, the first unit activated by the network and/or the first UE, or the first unit which the second UE and/or the second UE group request the first UE or network to activate;
the available time-frequency resources may be unoccupied time-frequency resources and/or time-frequency resources occupied by signals or channels with the lower priority than that of the current first resource.

In another embodiment, in order to further reduce positioning error caused by a single-sided one-way positioning measurement, a single-sided round-trip time (RTT) positioning method and/or a double-sided RTT positioning method can be adopted to further improve the positioning accuracy.

The configuration method of the first resources for implementing the single-sided RTT positioning method and/or the double-sided RTT positioning method may include one or more of the following:
starting from a time unit when the second UE receives the first resource, within the time unit with the time duration of Rp1, the network or the first UE or the second UE configures and/or activates the first resource for the second UE, and/or the second UE transmits the first resource. This way is more suitable for the position measurement performed by using the single-sided RTT positioning method, and can reduce the clock synchronization error between the transmitter and receiver;
starting from a time unit when the second UE receives the first resource, within the time unit with the time duration of Rp2, the network or the first UE or the second UE configures and/or activates the first resource for the second UE, and/or the second UE performs the transmission of the first resource. After the first UE receives the first resource transmitted by the second UE, starting from the time unit when the first UE receives the first resource transmitted by the second UE, within the time unit with the time duration of Rp3, the network or the first UE or the second UE configures and/or activates the first resource for the first UE and/or the first UE transmits the first resource. This way is more suitable for the position measurement performed by using the double-sided RTT positioning method, and can further reduce the clock synchronization error between the transmitter and receiver on the basis of the single-sided RTT positioning measurement method;
optionally, the time interval between two first resource configuration and/or activation and/or transmission for the second UE is less than or not more than Rp4 time units;
Rp1, Rp2, Rp3 and Rp4 are the parameter values reported by the user equipment UE according to its own processing capability, and/or the parameter values configured by the base station which are received by the UE, and/or the pre-configured parameter values, and Rp1, Rp2, Rp3 and Rp4 are real numbers greater than 0. Optionally, Rp1, Rp2 and Rp3 can be the same equal parameter value Optionally, Rp1, Rp2, Rp3 and Rp4 can be the same equal parameter value;
optionally, the network may configure the same first resource mapping pattern (comb size) for the first UE and the second UE that implements the single-sided RTT positioning method and/or double-sided RTT positioning method;
the network may be a base station and/or an LMF.

The measurement method of the first resource for implementing the single-sided RTT positioning method and/or double-sided RTT positioning method may include one or more of the following:
starting from a time unit where the first UE transmits the first resource, the first resource within the time length or time duration of Lr1 can be used for the single-sided RTT positioning measurement, and/or the first resource within the time length or time duration of Lr2 can be used for the double-sided RTT positioning measurement;
when the first UE and/or the second UE reserve one or more available time-frequency resources for transmission of the first resource by sensing or randomly selecting in the resource pool (for example, a dedicated resource pool and/or a shared resource pool), if starting from a time unit when the first UE transmitted the first resource, within the time length or time duration of Lr1, the first UE and/or the second UE cannot reserve more than Oc1 transmission resources for first resource, and/or within the time length or time duration of Lr2, the first UE and/or the second UE cannot reserve more than Oc2 transmission resources for first resource, only single-sided one-way positioning measurement is performed and the measurement result is reported, or the measurement result is dropped directly. The single-sided one-way positioning measurement may include at least one of the following: an RSTD (reference signal time difference) measurement, an RSRP (reference signal received power) measurement, an RSRPP (reference signal received path power) measurement, an RTOA (Relative Time of Arrival) measurement, an AOA (Azimuth of Arrival) measurement, a ZOA (Zenith of Arrival) measurement, an AOD (Angle Of Departure) measurement;
Lr1, Lr2, Oc1 and Oc2 are the parameter values reported by the user equipment UE according to its own processing capability, and/or the parameter values configured by the base station which are received by the UE, and/or the pre-configured parameter values, and Lr1, Lr2, Oc1 and Oc2 are real numbers greater than 0;
optionally, the TypeD Quasi-Colocation (QCL) relationship of the network or the first UE or the second UE within the time length of Lr1 and/or Lr2 does not change;
optionally, when the first UE and/or the second UE transmit the first resource twice or more, the first UE and/or the second UE use the same beam to transmit the first resource, and/or the TypeD quasi-co-location (QCL) relationship in two or more first resource transmission does not change, which is more suitable for the double-sided RTT positioning measurement.

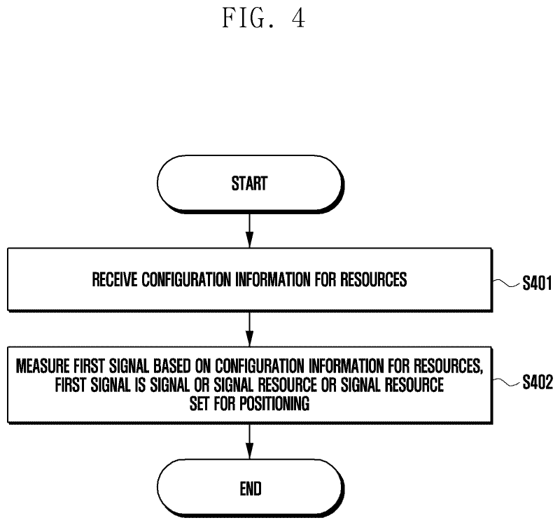

FIG. 4 is a flowchart of a method according to an embodiment of the present disclosure. According to an embodiment of the present disclosure, at step S401, the user equipment may receive configuration information for resources. At step S402, the user equipment may measure first signal based on the configuration information for resources, the first signal is signal(s) or signal resource(s) or signal resource set(s) for positioning.

1-15. (canceled)

16. A method performed by a first terminal in a wireless communication system, the method comprising:
identifying a shared sidelink(SL) positioning reference signal (PRS) resource pool used for a transmission of an SL PRS; and
based on the shared SL PRS resource pool, transmitting, to a second terminal, the SL PRS in consecutive symbols within a slot,
wherein the first terminal transmits the SL PRS in at least one physical sidelink shared channel (PSSCH) symbol in a time domain, and
wherein a frequency domain resource assignment for an SL PRS resource is the same as a PSSCH in a frequency domain.

17. The method of claim 16, wherein the first terminal does not transmit the SL PRS in at least one symbol where an associated physical sidelink control channel (PSCCH) is transmitted.

18. The method of claim 16, further comprising:
receiving, from the second terminal, information on an SL receive-transmit(Rx−Tx) time difference measurement,
wherein a time difference between the SL PRS transmission and a reception used to derive the information is no larger than a time duration.

19. The method of claim 16,
wherein an SL receive-transmit(Rx−Tx) time difference measurement is performed by the second terminal based on at least one of information on a starting point associated with the slot or information on a capability associated with an active SL PRS resource, and
wherein a bandwidth associated with the SL PRS is less than or equal to a bandwidth of a resource pool.

20. A method performed by a second terminal in a wireless communication system, the method comprising:
based on a shared sidelink(SL) positioning reference signal (PRS) resource pool, receiving, from a first terminal, an SL PRS in consecutive symbols within a slot,
wherein the second terminal receives the SL PRS in at least one physical sidelink shared channel (PSSCH) symbol in a time domain, and
wherein a frequency domain resource assignment for an SL PRS resource is the same as a PSSCH in a frequency domain.

21. The method of claim 20, wherein the first terminal does not transmit the SL PRS in at least one symbol where an associated physical sidelink control channel (PSCCH) is transmitted.

22. The method of claim 20, further comprising:
performing an SL receive-transmit(Rx−Tx) time difference measurement based on at least one of information on a starting point associated with the slot or information on a capability associated with an active SL PRS resource; and
transmitting, to the first terminal, information on the SL Rx−Tx time difference measurement,
wherein a bandwidth associated with the SL PRS is less than or equal to a bandwidth of a resource pool.

23. A first terminal in a wireless communication system, the first terminal comprising:
a transceiver; and
at least one processor coupled with the transceiver and configured to:
identify a shared sidelink(SL) positioning reference signal (PRS) resource pool used for a transmission of an SL PRS, and
based on the shared SL PRS resource pool, transmit, to a second terminal, the SL PRS in consecutive symbols within a slot,
wherein the first terminal transmits the SL PRS in at least one physical sidelink shared channel (PSSCH) symbol in a time domain, and
wherein a frequency domain resource assignment for an SL PRS resource is the same as a PSSCH in a frequency domain.

24. The first terminal of claim 23, wherein the first terminal does not transmit the SL PRS in at least one symbol where an associated physical sidelink control channel (PSCCH) is transmitted.

25. The first terminal of claim 23,
wherein the at least one processor is further configured to:
receive, from the second terminal, information on an SL receive-transmit(Rx−Tx) time difference measurement, and
wherein a time difference between the SL PRS transmission and a reception used to derive the information is no larger than a time duration.

26. The first terminal of claim 23,
wherein an SL receive-transmit(Rx−Tx) time difference measurement is performed by the second terminal based on at least one of information on a starting point associated with the slot or information on a capability associated with an active SL PRS resource, and
wherein a bandwidth associated with the SL PRS is less than or equal to a bandwidth of a resource pool.

27. A second terminal in a wireless communication system, the second terminal comprising:
a transceiver; and
at least one processor coupled with the transceiver and configured to:
based on a shared sidelink(SL) positioning reference signal (PRS) resource pool, receive, from a first terminal, an SL PRS in consecutive symbols within a slot,
wherein the second terminal receives the SL PRS in at least one physical sidelink shared channel (PSSCH) symbol in a time domain, and
wherein a frequency domain resource assignment for an SL PRS resource is the same as a PSSCH in a frequency domain.

28. The second terminal of claim 27, wherein the first terminal does not transmit the SL PRS in at least one symbol where an associated physical sidelink control channel (PSCCH) is transmitted.

29. The second terminal of claim 27, wherein the at least one processor is further configured to:
transmit, to the first terminal, information on an SL receive-transmit(Rx−Tx) time difference measurement.

30. The second terminal of claim 27,
wherein the at least one processor is further configured to:
perform an SL receive-transmit(Rx−Tx) time difference measurement based on at least one of information on a starting point associated with the slot or information on a capability associated with an active SL PRS resource, and
wherein a bandwidth associated with the SL PRS is less than or equal to a bandwidth of a resource pool.
